(19) United States
(12) Patent Application Publication
(10) Pub. No.: US 2026/0111659 A1
(43) Pub. Date: Apr. 23, 2026

(54) GRAPH DATABASE SYSTEM FOR ELECTRONIC COMMUNICATION

(71) Applicant: Notion Labs, Inc., San Francisco, CA (US)

(72) Inventors: Arpeet Kale, San Jose, CA (US); Nishil Shah, San Francisco, CA (US); Peter Lu, San Francisco, CA (US); Byeong Chan Lee, Long Island City, NY (US); Ryan Kuang, Pasadena, CA (US); Andrew Milich, San Francisco, CA (US)

(21) Appl. No.: 19/238,279

(22) Filed: Jun. 13, 2025

Related U.S. Application Data
(60) Provisional application No. 63/708,655, filed on Oct. 17, 2024.
(60) Provisional application No. 63/779,521, filed on Mar. 28, 2025.
(60) Provisional application No. 63/779,547, filed on Mar. 28, 2025.

(51) Int. Cl. G06F 40/186; G06F 16/35; G06F 16/901; G06F 40/194; G06F 40/30

(52) U.S. Cl. CPC G06F 40/186; G06F 16/35; G06F 16/9024; G06F 40/194; G06F 40/30

(57) ABSTRACT

A graph database system stores and analyzes connections and relationships between entities using a database structure that represents users, messages, threads, and attachments as nodes with interconnecting edges. The system implements a hybrid approach to electronic communication classification combining self-hosted language models with computer server clustering for pattern matching and suggestion generation. Additionally, the system includes mechanisms for creating and suggesting reusable electronic communication components based on semantic analysis of communication patterns. The system architecture enables relationship analysis, digital content management, and privacy-preserving electronic communication classification.

### CROSS-REFERENCE TO RELATED APPLICATION

This application claims the benefit of priority to U.S. Provisional Application No. 63/708,655, filed Oct. 17, 2024, U.S. Provisional Application No. 63/779,521, filed Mar. 28, 2025, and U.S. Provisional Application No. 63/779,547, filed Mar. 28, 2025, the contents of each of which are incorporated by reference in their entireties herein.

### BACKGROUND

Electronic communication systems have evolved since their inception, becoming one of the primary mediums for digital communication in personal and professional contexts. Traditional electronic communication systems can use relational databases to store and manage communication data, organizing messages, user information, and metadata into structured tables. These systems can implement various methods for categorizing electronic communications. However, conventional electronic communication systems struggle to effectively capture and analyze the complex web of relationships between users, messages, and communication patterns while maintaining computational efficiency and user privacy.

### BRIEF DESCRIPTION OF THE DRAWINGS

Reference will now be made, by way of example, to the accompanying drawings, which show example embodiments of the present application, and in which:

FIG. 1 is a block diagram of an example system to provide users with an all-in-one workspace for data and project management.

FIG. 2 is a block diagram of an example transformer.

FIG. 3 is a block diagram illustrating a hierarchical organization of pages in a workspace.

FIG. 4 is a block diagram illustrating an example graph database system.

FIG. 5 is a flow diagram that illustrates example operations of a graph database system.

FIG. 6 is a flowchart of a method for operating a graph database system.

FIG. 7 is a flowchart of a method for operating a semantic search cluster.

FIG. 8 is a block diagram illustrating an example artificial intelligence (AI) system that can implement aspects of the present technology.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The electronic communication landscape has become increasingly complex, with users having numerous relationships, threads, and content types spread across inboxes. Traditional electronic communication systems, built on relational databases, face significant challenges in capturing the intricate relationships between different electronic communication entities and providing meaningful insights from these connections. Previous approaches focused on simple metadata analysis and basic filtering mechanisms, but these methods failed to unlock the full potential of electronic communication data.

The implementations for graph-based relationship analysis of electronic communications disclosed herein include graph databases that represent the relationships between electronic communication entities. The disclosed systems model users, messages, threads, and attachments as nodes in a graph, with edges representing various relationships between the nodes. The graph database structure enables analysis of communication patterns, community detection, and relationship mapping that was previously computationally intensive or impossible with traditional database structures.

The disclosed approaches to electronic content classification use artificial intelligence (AI) methods with pattern matching. In some implementations, large language models (LLMs) are used alongside multiple computer servers working together to provide more accurate electronic communication classification while reducing computational costs and maintaining user privacy. Repeated application programming interface (API) calls to external services are avoided while classification accuracy is improved using user-specific pattern recognition. The challenges of electronic communication content reusability are addressed using an AI template suggestion system. By analyzing semantic patterns in sent electronic communications, more frequently used content is identified and reusable templates can be created. The disclosed features not only save time but can also provide consistency in communication while adapting to each user's unique communication style.

The graph database implementations enable features such as relationship visualization, influence mapping, and communication pattern analysis. By storing relationships as directed edges between entities, queries involving connections between entities can be processed, reducing the time required for complex relationship analysis. The systems disclosed are designed for scalability and privacy, e.g., each user's data can be maintained in separate clusters. Thus the pattern matching and suggestions can be made more relevant to individual users while improving data security and computational efficiency.

In some implementations, a graph database is generated that stores electronic communication entities as nodes and their relationships as edges. An email ingestion layer converts incoming electronic communications into graph entities, while a graph processing engine analyzes these relationships using various algorithms. Community detection, centrality analysis, and pattern recognition can be implemented to provide insights into communication patterns and user relationships.

In some implementations, a mechanism is implemented for generating and suggesting reusable electronic communication components. Sent electronic communications are monitored for repeated content patterns and semantic similarity is analyzed between electronic communication segments. When patterns are detected, an AI system can suggest creating templates with customizable fields. These templates are stored by the system and can be accessed through a user interface, with the system learning from template usage patterns.

In some implementations, an approach to electronic communication classification can combine a self-hosted LLM with a cluster of computer servers. The approach allows for more efficient electronic communication classification by maintaining user-specific pattern databases. Only a limited number of LLM API calls are needed after initial training because new electronic communications can be matched against previously classified patterns, reducing computational costs while maintaining classification accuracy.

The graph database systems disclosed herein provide advantages over traditional relational database approaches. By representing electronic communication entities and their relationships as nodes and edges in a graph, the systems enable complex relationship analysis that was previously computationally intensive or impossible. The disclosed structures enable more efficient querying of relationship-based data, such as finding communication patterns or identifying key influencers within an organization. The graph database approaches also facilitate features such as community detection, sentiment flow analysis, and anomaly detection, providing users with deeper insights into their communication patterns.

The approaches to electronic communication classification and template generation disclosed herein also offer benefits in terms of computational efficiency and privacy. By combining self-hosted LLMs with computer server clustering, the disclosed systems reduce the need for external API calls while maintaining accuracy in classification and suggestions. The user-specific pattern databases provide more relevant suggestions and classifications to individual users, while the local processing approach improves data privacy and reduces computational costs. The architectures disclosed herein also enable rapid scaling and adaptation to user needs as the systems learn from user interactions without requiring repeated updates to the core classification model.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type of attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor or dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the UI to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

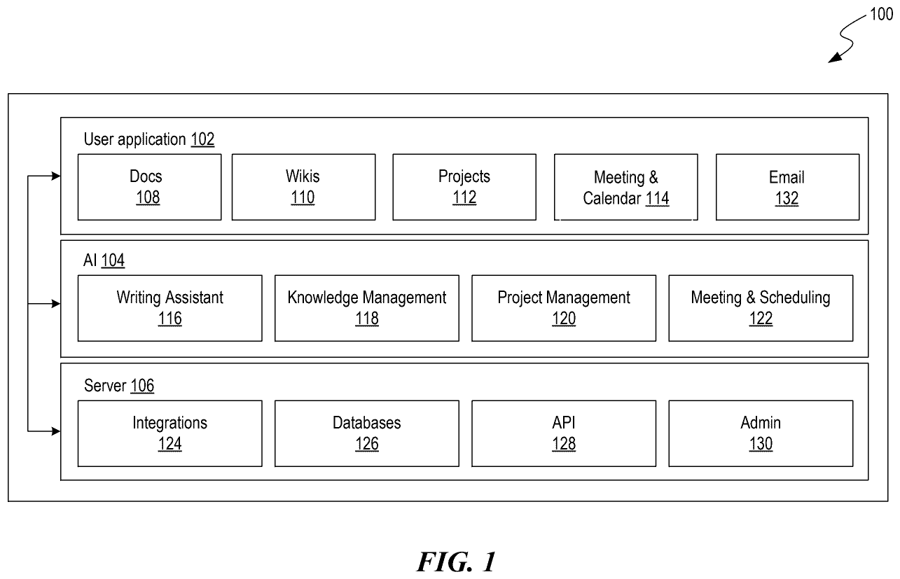

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a pre-built page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, electronic communications, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules such as “Archive this,” or assistant workflows such as responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an electronic communication sent from an email address within the platform 100 to another email address within the platform 100 can include an embedding of a document within the platform 100, or an embedding of a block within the document. In another example, a wiki can link to a meeting within the calendar.

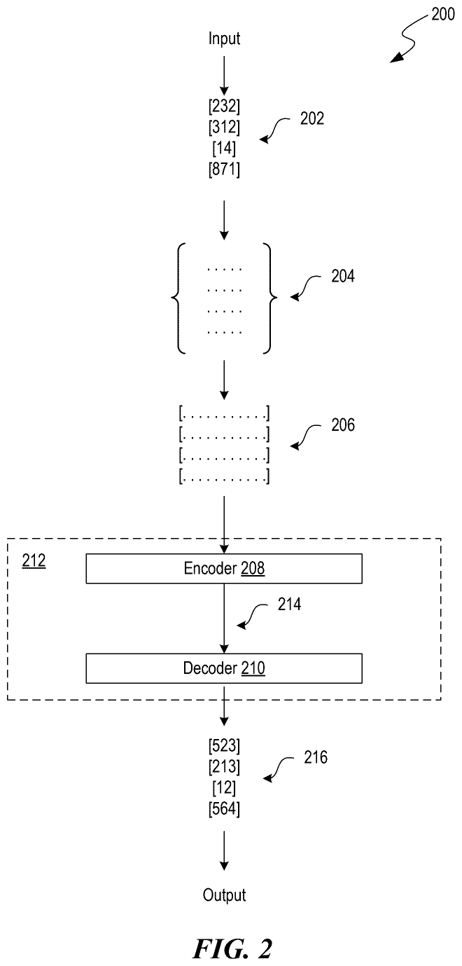

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, when compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimizing a loss or maximizing a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant-trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam electronic communications), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an electronic communication, a blog post, a social media post, or a poem. Fixing spelling and grammar can include correcting errors in an existing input text. Translating can include converting an existing input text into a variety of different languages. In some implementations, the transformer 212 is trained to perform certain functions on input formats other than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts, such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary”token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the internet. In some implementations, such as in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

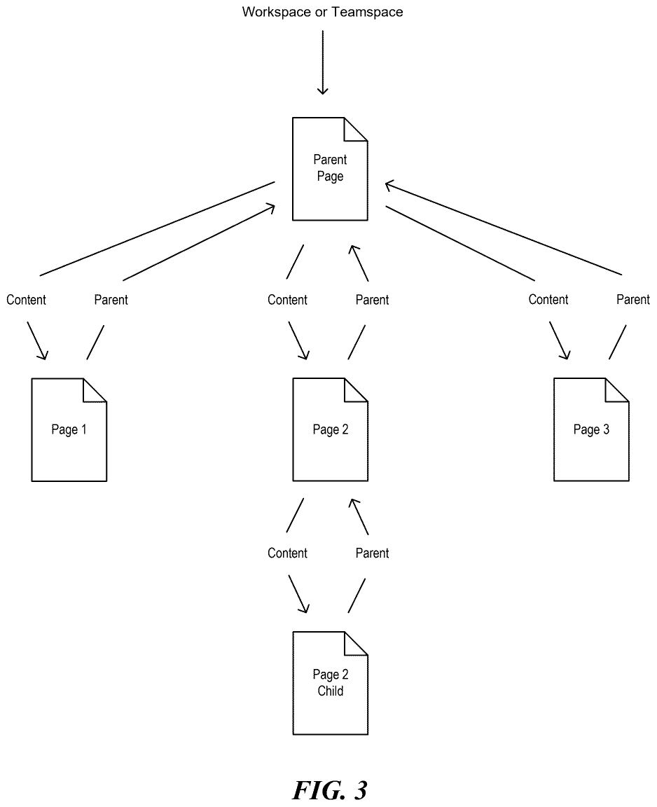

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include sub-pages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Graph Database System for Electronic Communication

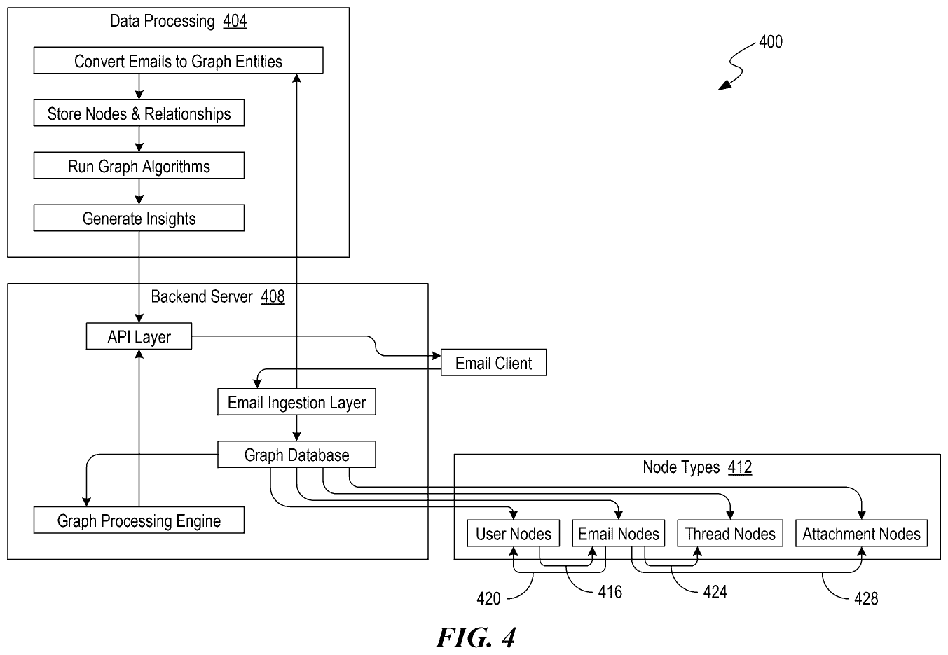

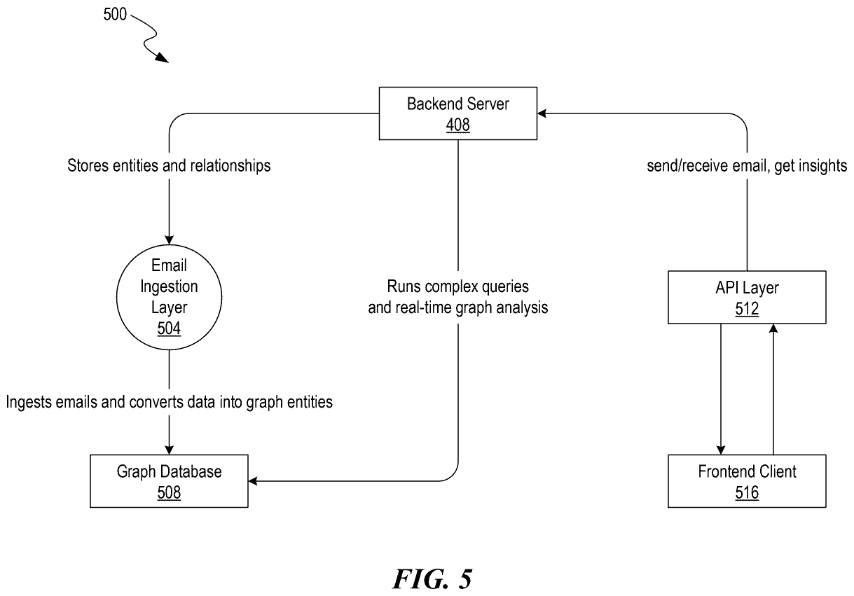

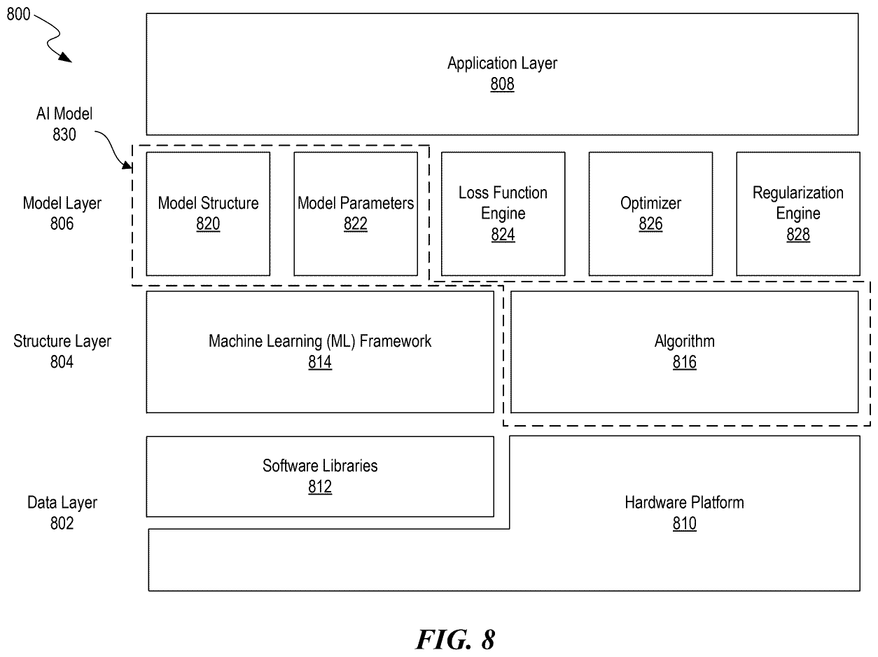

FIG. 4 is a block diagram illustrating an example graph database system 400. The system 400 includes a data processing engine 404, a backend server 408, and multiple nodes 412 of a graph database structure (e.g., the graph database 508 illustrated and described in more detail with reference to FIG. 5). The system 400 is implemented using components of the computer system 800 illustrated and described in more detail with reference to FIG. 8. Likewise, implementations can include different and/or additional steps or can perform the steps in different orders.

FIG. 4 provides a visualization of the graph database system, illustrating the data flow and component interactions from electronic communication ingestion through insight generation. For example, FIG. 4 shows how electronic communication data is transformed into graph entities, processed through various analytical components, and ultimately delivered back to users as actionable insights, highlighting the system's approach to electronic communication relationship analysis. The system 400 includes several interconnected components organized into distinct functional groups. The main processing flow begins with an email client (e.g., the frontend client 516 illustrated and described in more detail with reference to FIG. 5) interfacing with the components of the backend server 408, including the email ingestion layer (e.g., the email ingestion layer 504 illustrated and described in more detail with reference to FIG. 5), graph database, graph processing engine, and API layer (e.g., the API layer 512 illustrated and described in more detail with reference to FIG. 5). The data processing engine 404 transforms raw electronic communications into graph entities and performs storage of nodes and relationships, execution of graph algorithms, and insight generation. The multiple nodes 412 include four fundamental node categories: user nodes, electronic communication nodes (sometimes referred to as email nodes), thread nodes, and attachment nodes, which form the basis of the graph database structure.

The architecture shown by FIG. 4 includes the email client, which serves as the primary interface for user interactions. The email client communicates with components of the backend server 408 through a secure channel, enabling bidirectional flow of electronic communication data and analytical insights. The email ingestion layer implements algorithms for converting traditional electronic communication formats into graph-compatible entities. Incoming electronic communication is processed by parsing sender information, recipient details, subject lines, message content, or attachments. The ingestion process creates or updates various node types while establishing appropriate edges to represent relationships between entities.

The graph database component implements a storage mechanism that maintains four primary node types. User nodes contain information such as email addresses, names, or organizational roles. Electronic communication nodes (sometimes referred to as email nodes) store message content, timestamps, or status information. Thread nodes manage conversation chains by linking related communications. Attachment nodes represent shared files or documents, maintaining connections to their source electronic communications. The graph processing engine implements various analytical algorithms for relationship analysis. It can execute community detection algorithms such as LOUVAIN or GIRVAN-NEWMAN to identify communication clusters and determine centrality measures (such as degree, betweenness, or closeness) to determine key users and influencers. The graph processing engine also performs temporal analysis by examining edge timestamps to detect communication patterns or response time metrics.

The data processing engine 404 initiates the transformation pipeline, beginning with the conversion of electronic communications into graph entities. This process involves extracting structured data and creating appropriate nodes and edges. The system 400 stores these elements in the graph database, maintaining temporal properties and metadata for each relationship. The graph algorithms execute various analyses, including sentiment tracking, spam detection, or topic clustering. The nodes 412 are the fundamental building blocks of the graph database structure. User nodes serve as vertices for sender and recipient information, enabling social network analysis or relationship mapping. Electronic communication nodes act as containers for message content or metadata, facilitating content analysis or pattern detection. Thread nodes manage conversation flow or evolution, while attachment nodes track shared resources or document collaboration.

The API layer implements an interface for executing complex queries or performing real-time graph analysis. It exposes endpoints for retrieving communication clusters, identifying key influencers, or tracking topic evolution. The API layer also supports various analytical functions and can enables spam detection through pattern analysis. The system 400 implements privacy-preserving measures by maintaining user-specific pattern databases and reducing external API calls through local processing. The architecture supports scalability through its graph database structure, allowing for handling of complex relationships without performance degradation.

The graph processing engine's algorithms enable features such as dynamic electronic communication prioritization, contextual recommendations, or handling of multi-party communications. The graph processing engine supports topic clustering through NLP techniques, enabling the grouping of electronic communications by common themes or project-based communication analysis. The feedback loop between components of the system 400 enables learning and improvement of the system's analytical capabilities. As users interact with the email client, their actions and communication patterns are processed through the pipeline, enriching the graph database and refining the system's understanding of relationship dynamics. This iterative process enhances the accuracy of insights and recommendations over time.

In some implementations, the system 400 processes electronic communications through several interconnected stages to build and analyze a graph database. The system 400 obtains electronic communications sent and received across multiple users'mailboxes. These communications form the foundational data that will be analyzed and transformed. The system 400 can use a hybrid approach combining an LLM and/or semantic search to generate and assign labels to the electronic communications. An example LLM is described in more detail with reference to FIG. 2. A self-hosted LLM and/or an open-source LLM can be used to suggest labels for the electronic communications. The labeled communications can be stored in a semantic search cluster, which enables retrieval and analysis of similar content.

As new electronic communications are received, the system 400 leverages the existing semantic search cluster to assign labels. Rather than processing every new electronic communication through the LLM, the system 400 can match incoming communications against previously labeled electronic communications in the cluster to determine appropriate labels. This approach reduces computational costs while maintaining accuracy, as it only needs to process through the LLM approximately 5% of electronic communications after the initial training period. The system 400 analyzes the communications to determine the multiple entities involved, such as users, messages, and attachments. The entities are transformed into nodes within the graph database, creating a network of interconnected elements. The graph database represents each entity as a distinct node, allowing for complex relationship mapping.

Edges are generated between the nodes 412 to represent various types of relationships, such as sender-recipient connections, topic links, or reply chains. The edges capture the nature and strength of relationships between entities, enabling analysis of communication patterns. For example, a sender edge 416 connects a user node to an electronic communication node. A recipient edge 420 connects an electronic communication node to one or more user nodes. A thread edge 424 connects one or more electronic communication nodes to a thread node. An attachment edge 428 connects an electronic communication node to one or more attachment nodes.

Thread edges and attachment edges are relationship connectors within the graph database structure. Thread edges link individual email nodes to thread nodes to establish conversation connections and manage the evolution of email discussions. These edges enable tracking of branching conversations, parallel discussions, and the thread hierarchy. The system 400 uses thread edges to analyze communication patterns and maintain the sequential flow of conversations, enabling analysis of how discussions evolve over time and branch into different subtopics. Attachment edges connect email nodes to attachment nodes, representing the relationship between messages and their associated files, documents, or links. These edges contain metadata including timestamps or interaction frequencies, enabling temporal analysis of document sharing patterns. The attachment edges facilitate tracking of document collaboration patterns and resource sharing within teams, providing insights into how files are distributed across communication networks. This structure allows the system 400 to identify the most frequently shared documents within teams and analyze document collaboration patterns over time.

The system 400 can detect communication clusters within the graph database using clustering algorithms. Clusters reveal groups of users who frequently communicate and/or topics that are commonly discussed together. The system 400 can identify formal organizational structures and/or informal communication patterns that emerge organically. The system 400 can analyze the edges within the graph database structure to detect communication hubs—key users or entities that serve as central points in the communication network. Hubs might represent influential individuals, critical information conduits, and/or important discussion topics within the organization.

In some implementations, the system 400 provides an API layer that enables querying of the graph database to extract insights about communication clusters and hubs. This API allows integration with email clients or other applications to surface these insights to users. System 400 can perform spam and/or fraud detection through pattern analysis across mailboxes, implementing clustering algorithms to identify large-scale spam campaigns and unusual communication patterns. The graph database structure enables tracking of electronic communication thread evolution, including branching conversations and parallel discussions, while supporting role-based communication analysis for understanding inter-departmental dynamics. The system's design supports cross-channel integration capabilities, allowing for unified communication analysis across different platforms while maintaining data privacy and security through its user-specific clustering approach. The system 400 enables prioritization of emails based on graph analysis and contextual recommendations.

FIG. 5 is a flow diagram that illustrates example operations of a graph database system 500 for electronic communication. The system 500 can be implemented using components of the computer system 800 illustrated and described in more detail with reference to FIG. 8. Particular entities, for example, the backend server 408, perform some or all of the operations in other implementations. The backend server 408 is illustrated and described in more detail with reference to FIG. 4. Likewise, implementations can include different and/or additional steps or can perform the steps in different orders.

FIG. 5 depicts the interaction flow between components of the backend server 408 and the frontend client 516, highlighting how electronic communications are ingested, processed, and analyzed through the graph database infrastructure. FIG. 5 shows the email ingestion layer 504, which handles incoming electronic communication data conversion; the graph database 508, which serves as the storage system for entities and relationships; and the API layer 512, which facilitates communication between the backend server 408 and frontend client 516. The email ingestion layer 504 converts raw electronic communications into graph entities, while the graph database 508 stores these entities and their relationships. The API layer 512 runs complex queries and enables real-time graph analysis, providing an interface for the frontend client 516 to send/receive electronic communication and retrieve insights.

The graph system 500 illustrated by FIG. 5 enables relationship analysis and electronic communication management. The email ingestion layer 504 serves as an entry point for electronic communication processing, implementing algorithms to convert traditional electronic communication formats into graph-compatible entities. This layer is responsible for parsing incoming electronic communications to extract structured data, including sender information, recipients, subject lines, body content, and attachments. The ingestion process creates or updates user nodes for each sender and recipient, establishes electronic communication nodes for message metadata, and generates appropriate edges to represent the relationships between these entities.

The graph database 508 implements a storage mechanism for electronic communication entities as nodes (e.g., nodes 412 illustrated and described in more detail with reference to FIG. 4) and their relationships as edges. The database 508 is designed to handle various node types, including user nodes containing email addresses and/or organizational roles, electronic communication nodes storing message content and/or timestamps, thread nodes linking related communications, and attachment nodes representing shared files and/or documents. The edges between these nodes capture complex relationships such as sender-recipient interactions, thread associations, and attachment connections, and can be tagged with relevant temporal properties and/or metadata.

The system's API layer 512 implements an interface for executing complex queries and performing real-time graph analysis. This layer can support analytical functions, including community detection algorithms such as LOUVAIN or GIRVAN-NEWMAN for identifying communication clusters, centrality measures for determining key users and influencers, and/or shortest path calculations for mapping indirect relationships. The API layer 512 can perform sentiment analysis, tracking conversation tone changes over time, and enables spam detection through pattern analysis. The system 500 can perform temporal insight generation, analyzing timestamps on edges to detect communication patterns and response time metrics. The system 500 can implement clustering algorithms to group similar electronic communications, enabling template suggestion and/or content reuse. The API layer 512 can expose endpoints for retrieving communication clusters, identifying key influencers, and/or tracking topic evolution across electronic communication threads.

The frontend client 516 can interact with the backend server 408 through the API layer 512, enabling users to send and receive electronic communication while accessing analytical insights. The system 500 can implement privacy-preserving measures by maintaining user-specific pattern databases and reducing external API calls through local processing. The graph database structure supports scalability, enabling handling of complex relationships without performance degradation. The graph processing engine can implement algorithms for relationship analysis, including degree, betweenness, and/or closeness determinations. The determinations help identify communication hubs and bridges between groups, supporting organizational analysis and leadership mapping. The engine also supports topic clustering through NLP techniques, enabling the grouping of electronic communications by common themes and project-based communication analysis.

In some implementations, the architecture facilitates spam and/or fraud detection through pattern analysis across mailboxes, implementing clustering algorithms to identify large-scale spam campaigns and/or unusual communication patterns. The graph database structure enables tracking of electronic communication thread evolution, including branching conversations and/or parallel discussions, while supporting role-based communication analysis for understanding inter-departmental dynamics. The architecture of system 500 enables features such as prioritization of emails based on graph analysis, contextual recommendations leveraging communication patterns, and/or efficient handling of multi-party communications. The system 500 can support cross-channel integration capabilities, allowing for unified communication analysis across different platforms while maintaining data privacy and security through its user-specific clustering approach.

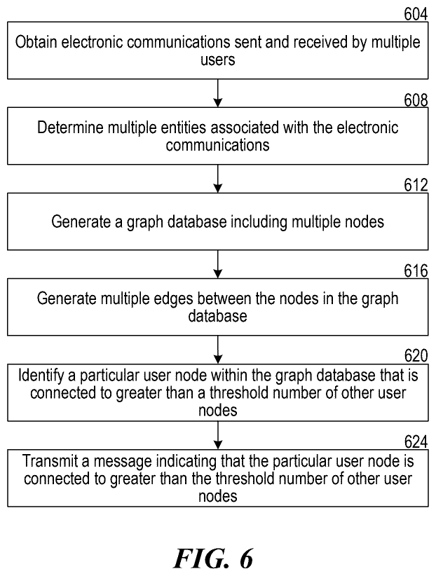

FIG. 6 is a flowchart of a method for operating a graph database system for electronic communication. In some implementations, the method is performed by the system 400 illustrated and described in more detail with reference to FIG. 4. The method can be performed by the computer system 800 illustrated and described in more detail with reference to FIG. 8. Particular entities, for example, the backend server 408, perform some or all of the steps of the method in other implementations. The backend server 408 is illustrated and described in more detail with reference to FIG. 4. Likewise, implementations can include different and/or additional steps or can perform the steps in different orders.

At 604, a system obtains electronic communications through an email ingestion layer that can pull the electronic communications from various electronic communication service providers using APIs such as GMAIL API, MICROSOFT OUTLOOK API, or IMAP protocols. During the ingestion process, the system parses each incoming electronic communication to extract structured data including the sender, recipients, subject, body, and/or attachments. As part of the account setup process, the system can import historical sent electronic communications from a user's electronic communication account. The historical data import can focus on electronic communications sent from the account in the recent past (e.g., the last month) to establish baseline communication patterns.

The email ingestion layer (e.g., email ingestion layer 504 illustrated and described in more detail with reference to FIG. 5) converts the raw electronic communications into graph entities, creating nodes (e.g., nodes 412 illustrated and described in more detail with reference to FIG. 4) for different types of entities such as users, electronic communications, electronic communication threads, and attachments. For each parsed message, the system creates or updates user nodes for each sender and recipient, creates an electronic communication node to store the electronic communication metadata, and establishes the appropriate relationships between these nodes through directed edges that represent sender-recipient relationships. The ingested electronic communications are stored in a graph database (e.g., graph database 508 shown by FIG. 5) that enables complex queries and real-time graph analysis. The graph database enables the system to store and process relationships between entities while maintaining the ability to perform analysis of communication patterns across multiple users'mailboxes.

At 608, the system determines entities by analyzing parsed electronic communication data to identify distinct components. Each entity represents a different aspect of electronic communications—users represent senders and recipients, electronic communications contain message metadata, and thread nodes link related electronic communications together. Attachment entities store attached documents, audio clips, files, etc.

At 612, the system generates a graph database by creating distinct node types for the entities: electronic communication nodes store message metadata and/or content, user nodes contain properties like email addresses and/or organizational roles, and thread nodes link related electronic communications together in conversation chains. Each electronic communication node is connected to corresponding user nodes through directed edges representing sender-recipient relationships, while thread nodes aggregate metadata about conversations and maintain links to related electronic communication nodes. The graph database enables complex queries and real-time analysis of these interconnected nodes and their relationships. The system can also attribute additional properties to entities—for example, user entities can be attributed as person entities with associated metadata. The backend server handles storing entities and relationships in the graph database (e.g., NEO4J, ARANGODB, or AWS NEPTUNE) while enabling complex queries and real-time graph analysis.

The thread nodes in the graph database serve as organizational structures that manage conversation chains by linking related emails together and tracking participant relationships. Thread nodes can aggregate metadata about conversations and maintain links to related email nodes through “thread” edges that connect email nodes to thread nodes, establishing the membership of users in specific conversation threads. The system tracks these relationships by analyzing the sender-recipient connections within threads, enabling identification of participants involved in a conversation chain. The thread nodes map how communication flows across multiple users by maintaining the relationships between individual email nodes and their participants, enabling the system to understand group communication patterns and track how conversations evolve between thread members over time.

The graph database can be stored using the block data model described in reference to FIG. 1 where blocks are dynamic units of information that can be transformed and moved across workspaces. Each block represents a singular piece of information, with blocks being nested inside other blocks (e.g., infinitely nested sub-pages inside pages). Every block has attributes including a unique identifier (ID), properties, and type that determine how information is rendered and organized. The blocks can inherit permissions from blocks in which they are located hierarchically through a parent attribute, which acts as an “upward pointer” for the permission system. Each node in the graph database is stored in a block that contains a unique ID for referencing across the database, with content attributes representing nested content and/or custom attributes specific to that node type. The block model maintains relationships between blocks through content arrays storing block IDs.

Each block can represent an electronic communication entity. Each block has a unique identifier that enables referencing across the database. The blocks contain content attributes stored as arrays of block IDs that reference nested content, such as threaded messages or attachments within communications. For permissions inheritance, blocks can use a parent attribute that acts as an “upward pointer” to define hierarchical relationships, where child blocks inherit access permissions from their parent blocks in the tree structure. The system can use the parent pointers to efficiently implement permission checks by traversing up the ancestor path to the workspace root.

At 616, the system generates edges between nodes to represent different types of relationships and connectivity in the electronic communications. Directed sender edges are created to connect user nodes to electronic communication nodes, indicating the sender relationship, while recipient edges connect electronic communication nodes to user nodes to represent recipient relationships. Additionally, thread edges link electronic communication nodes to thread nodes to show conversation connections. Each edge can contain metadata like timestamps and frequency of interactions to enable temporal analysis. The edges form the foundation for analyzing communication patterns, with upward parent pointers and downward content pointers mirroring each other to enable permission inheritance and relationship tracking. The system processes these relationships during email ingestion, establishing appropriate edges as new messages are parsed and converted into graph entities.

In some implementations, the graph database stores metadata on edges that capture temporal properties and interaction details. Each edge can contain metadata including timestamps and frequency of interactions to enable temporal analysis. The system can leverage edge metadata to analyze communication patterns by examining timestamps on edges to detect peak communication hours, weekly patterns, and seasonal cycles. The graph processing engine can determine response time metrics by analyzing the temporal metadata stored on sender-recipient edges to track how quickly users respond to each other and identify patterns such as delayed responses or frequent back-and-forth exchanges during high-urgency situations. The temporal analysis enables insights into communication dynamics and responsiveness across the organization. The graph processing engine can analyze the temporal properties and metadata stored on edges to generate insights about communication frequency, response time metrics, and evolving interaction patterns over time. The temporal analysis capability enables the system to understand and track how communication patterns and response behaviors change across different time periods.

At 620, the system identifies a particular user node within the graph database that is connected to greater than a threshold number of other user nodes. The particular user node (a communication hub) is identified using at least one centrality metric determined using the sender edges, the recipient edges, and/or the thread edges. For example, the system identifies communication hubs by analyzing the edges between nodes in the graph database to detect key users or entities that serve as central points in the communication network. The system can determine various centrality metrics (degree, betweenness, and/or closeness) to identify users who act as communication hubs or bridges between groups. The graph processing engine examines the frequency and patterns of sender-recipient relationships represented by directed edges, along with temporal metadata stored on those edges, to identify users who frequently communicate across different groups or serve as key information conduits within the organization. This analysis reveals influential individuals who may not be evident in traditional organizational charts by examining their connection patterns and communication frequency across the network of sender edges, recipient edges, and thread associations. The system can also leverage graph algorithms to analyze edge patterns and connection strengths between nodes.

The graph processing engine can analyze degree centrality, which measures direct connections between nodes, betweenness centrality, which identifies nodes that bridge different groups, and/or closeness centrality, which evaluates how quickly a node can reach other nodes in the network. The centrality measurements help identify communication hubs and bridges between groups by examining the patterns of sender edges, recipient edges, and thread edges connecting the nodes.

At 624, the system transmits a message to a user device (e.g., laptop, desktop, smartphone, or tablet) indicating that the particular user node is connected to greater than the threshold number of other user nodes. The system can provide an API that exposes endpoints for querying the graph database and retrieving insights about communication hubs. When a user is identified as a communication hub based on centrality metrics, the system can surface these insights directly to users through the frontend client interface. Specifically, the API processes queries about key influencers and communication patterns, then returns results that can be displayed in email clients or analytics platforms. The frontend client receives these insights through the API layer, enabling users to see communication patterns and relationship dynamics without being directly exposed to the underlying graph structure. The system focuses on surfacing actionable insights and recommendations to users rather than showing the technical details of the graph relationships.

The API can support complex queries such as identifying communities, tracking response times, and/or detecting communication patterns. For example, the API can execute queries to find communication clusters based on graph clustering algorithms or identify users with high centrality scores (e.g., on a scale of 0-100) who act as key influencers. The API layer (e.g., API layer 512 shown by FIG. 5) interfaces between the frontend client (e.g., frontend client 516 illustrated and described in more detail with reference to FIG. 5) and backend server, enabling access to the graph database (e.g., NEO4J, ARANGODB, AWS NEPTUNE). Clients can query the graph using query languages such as Cypher (for NEO4J) or Gremlin (for AWS NEPTUNE) to extract insights about communication clusters and hubs. The API processes these queries and returns results that can be surfaced in email clients or analytics platforms.

In some implementations, the system detects spam by analyzing anomalous patterns across mailboxes in the graph database. The graph processing engine can examine unusual patterns in electronic communication traffic by tracking communication patterns and comparing them to users'historical behavior. The system can identify spam by detecting patterns such as frequent communication from previously unknown users or when one entity/email address has an unusually high number of connections to multiple users. Additionally, the system can identify large-scale spam campaigns by analyzing clusters of similar suspicious content and observing patterns across different domains—for example, detecting when similar spam patterns emerge from different but related email addresses (e.g., updates@domain.com and marketing@domain. com). The system can also detect spam by comparing current communication patterns against historical patterns stored in the graph to identify anomalous changes in behavior or suspicious new patterns.

The system can use clustering or community detection algorithms to detect communication clusters within the graph database by analyzing patterns of interactions between nodes. The system can use density-based methods, hierarchical methods, and/or partitioning methods to identify tightly-knit groups of users who frequently communicate. For example, the system can use k-means clustering to partition observations into clusters where each observation belongs to the cluster with the nearest mean. The clustering algorithms analyze the edges between user nodes to identify groups that share common communication patterns or frequently interact, enabling detection of both formal organizational structures and/or informal communication patterns. The graph processing engine can use algorithms such as LOUVAIN or GIRVAN-NEWMAN to detect tightly-knit groups of users, which can help visualize work teams, social circles, or departmental clusters within an organization. Community detection reveals natural groupings based on communication frequency and shared characteristics between user nodes.

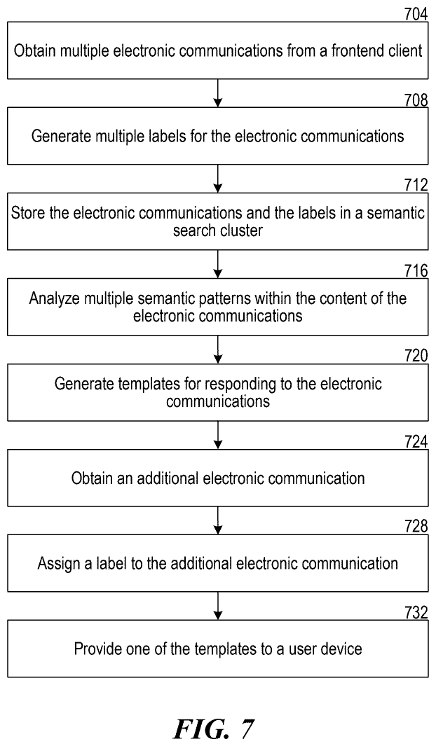

FIG. 7 is a flowchart of a method for operating a semantic search cluster. In some implementations, the method is performed by the system 400 illustrated and described in more detail with reference to FIG. 4. The method can be performed by the computer system 800 illustrated and described in more detail with reference to FIG. 8. Particular entities, for example, the backend server 408, perform some or all of the steps of the method in other implementations. The backend server 408 is illustrated and described in more detail with reference to FIG. 4. Likewise, implementations can include different and/or additional steps or can perform the steps in different orders.

At 704, a system obtains electronic communications through an email ingestion layer that pulls the electronic communications from various email service providers using APIs such as GMAIL API, MICROSOFT OUTLOOK API, or IMAP protocols. During the ingestion process, the system parses each incoming electronic communication to extract structured data including sender, recipients, subject, body content, and attachments. As part of the account setup process, the system can import historical sent electronic communications from the user's email account, focusing on emails sent in the recent past (e.g., the last month) to establish baseline communication patterns.

At 708, the system can use a self-hosted large language model (LLM) and/or open-source LLM capabilities to generate labels for electronic communications. When an electronic communication enters the system, it is processed through the LLM(s) to determine potential labels or classifications that indicate the content and purpose of the message. The system can leverage self-hosted LLM and/or open-source LLM components to suggest appropriate labels, balancing efficiency with accuracy. The labeling process can use ML techniques including supervised and/or unsupervised learning approaches to analyze and classify the content. For supervised learning, the system is trained on labeled training data to learn patterns and map input communications to appropriate content labels, while unsupervised learning helps identify natural groupings and classifications based on the communication content.

At 712, the system stores the electronic communications and their associated labels in a semantic open search cluster that enables retrieval and analysis of similar content. When electronic communications and their associated labels are processed, they are indexed in the cluster to allow for semantic matching rather than just exact textual matches, meaning the system can identify emails with similar meaning or purpose even if they don't use identical words. The cluster maintains associations between electronic communications and their labels, allowing the system to match new incoming emails against previously labeled content. The cluster acts as a database distributed across multiple computer servers that stores the email content and the semantic relationships between different emails and their classifications. This architecture enables the system to perform semantic-based queries to find related content and apply appropriate labels to new communications. The semantic search cluster can be integrated with the graph database backend, allowing the system to maintain the semantic relationships between email content and the structural relationships between entities.

In some implementations, the semantic search cluster is implemented using the block data model described in more detail with reference to FIG. 1, where blocks are dynamic units of information that can be transformed and moved across workspaces. Each electronic communication can be stored in a block that represents a singular piece of information within the system. The blocks can be nested infinitely inside other blocks, similar to how sub-pages can be nested within pages, creating a hierarchical structure for organizing the communications. Every block can have essential attributes including a unique identifier (ID) that makes it uniquely identifiable across the system, properties containing custom attributes specific to that block, and/or a type that determines how the information is rendered and organized. The blocks can inherit permissions from blocks in which they are located hierarchically through a parent attribute, which acts as an “upward pointer” for the permission system. Blocks can be referenced by multiple content arrays. Each block can have properties that can include custom attributes about emails, such as title, content, and/or metadata. The block model enables and maintains relationships between blocks through content arrays storing block IDs, which is useful for collaboration and organizing electronic communications.

At 716, the system analyzes semantic patterns in the electronic communications using one or more approaches. The system can employ topic clustering by analyzing the content of email subjects and bodies to group emails by common themes, using NLP techniques like term frequency-inverse document frequency (TF-IDF) methods or word embeddings to identify key themes. The semantic analysis enables identification of emails with similar meaning or purpose even if such emails don't use identical words. The system can perform sentiment analysis to track the tone of conversations and detect how sentiment changes over time between users. Additionally, the system can analyze temporal patterns by examining timestamps and/or communication frequency to detect peak communication hours, weekly patterns, and/or seasonal cycles. The semantic pattern analysis helps identify communication clusters, topic evolution across email threads, and/or enables features like dynamic email prioritization based on content analysis.

In some implementations, the system performs sentiment flow analysis by tracking the tone of conversations and detecting sentiment changes over time between users within the semantic search cluster. The graph processing engine can analyze the content of email subjects and bodies using NLP techniques to identify emotional tone and sentiment patterns. The system can use semantic pattern analysis to track sentiment shifts in communication over time, giving users the ability to monitor the tone of their conversations with specific contacts or teams. The sentiment analysis capabilities can be integrated with the temporal analysis features, enabling detection of how conversation tone evolves across different time periods and communication threads.

In some implementations, the system detects spam by analyzing semantic patterns across multiple mailboxes using the graph database structure. When examining a particular electronic communication, the system can use clustering algorithms to identify large-scale spam campaigns by analyzing the connections between multiple senders or email patterns. The system can examine behavioral patterns and communication frequency, looking for anomalous patterns such as frequent communication from previously unknown users or groups of emails with similar suspicious content. The graph-based approach can identify spam clusters by analyzing the semantic patterns and connections between multiple senders. The system can also examine historical behavior patterns from domains, subdomains, and/or users to detect anomalies between past and current communication patterns that may indicate spam activity. The behavioral anomaly detection enables identification of spam by leveraging graph analytics to detect unusual patterns of communication.

At 720, the system analyzes sent emails to identify repeated content patterns and semantic similarity between email segments using one or more LLMs. When patterns are detected, the AI system can create and suggest templates with customizable fields based on commonly used content. A writing assistant tool, powered by the transformer architecture, can generate writing in particular styles that serve as starting points for users'communications. The system can leverage self-hosted and/or open-source LLMs to analyze semantic patterns in the content and suggest appropriate templates, while improving efficiency by reducing repeated LLM processing. The templates can be accessed through a UI, with the system learning from template usage patterns to improve suggestions. The system can adapt to each user's unique communication style and common response patterns.

At 724, a new electronic communication is received. It enters the system through the email ingestion layer which processes incoming emails in real time. The ingestion layer pulls the new electronic communication from the email service provider and parses it to extract structured data including sender, recipients, subject, body and/or attachments.

At 728, the system checks the semantic search cluster to find existing electronic communications and their associated labels that are similar to the new electronic communication. The system analyzes semantic meaning rather than exact text matches, enabling identification of communications with similar purposes even if they use different words. If there are sufficient matches in the semantic cluster, the system can assign labels based on those similar communications without requiring additional LLM processing. The system leverages the semantic search cluster to match incoming communications against previously labeled emails, examining the content and context to identify emails with similar meaning or purpose. When a match is found, the system takes the labels that were assigned to the matching emails and applies them to the new email. This semantic matching approach reduces computational costs while maintaining classification accuracy, as only about 5% of new emails need full LLM processing after the initial training period. The system's semantic search capabilities enable it to understand and match the meaning and intent of communications rather than relying solely on exact text matching.

At 732, the system provides reusable templates through its API layer and frontend client interface. When a semantically similar email is identified, the system surfaces relevant templates that were previously generated based on common communication patterns. A writing assistant tool, which leverages the transformer architecture, can provide these templates in the appropriate style and format through a UI. The templates can include customizable fields that can be modified to match the specific context while maintaining consistent communication patterns. The system can deliver the templates through the frontend client, which receives the template suggestions via the API layer that connects to the backend server. The templates can be refined based on usage patterns to improve relevance and adapt to each user's unique communication style. The template suggestion system helps maintain consistency while allowing for personalization in email responses.

In some implementations, the system provides an API layer that exposes endpoints for executing complex queries and/or performing real-time analysis of the semantic search cluster. The API layer implements an interface that can support various analytical functions, including retrieving communication clusters, identifying key influencers, and/or tracking topic evolution across email threads. Clients can query the semantic search cluster using an API to find related content and/or apply appropriate labels to new communications. The API processes these queries and returns results that can be surfaced in email clients or analytics platforms. The frontend client can interact with the backend server through this API layer, enabling users to send and receive electronic communications while accessing analytical insights about communication patterns and relationships. The API layer facilitates communication between the frontend client and backend server, providing a flexible query interface for client applications to interact with both the graph database and semantic search capabilities.

The semantic search cluster approach reduces API calls to language models by storing and reusing previously labeled content. When new electronic communications are received, the system checks the semantic search cluster to find similar existing communications and their associated labels rather than immediately processing through the LLM. This matching against previously labeled content means only about 5% of new emails need full LLM processing after the initial training period, reducing the number of required API calls. The system can use the semantic search capabilities to identify emails with similar meaning or purpose even if they use different words, allowing it to apply existing labels without making additional LLM API calls. The disclosed approach not only reduces computational costs but also improves security since less data needs to be sent to external LLM services. The semantic cluster acts as a cache that enables label assignment based on semantic similarity rather than requiring repeated LLM processing.

The system can train the language models using supervised and/or unsupervised learning approaches. For supervised learning, the additional electronic communication can be used as training data that is labeled based on one or more classes and input to the model for training. The system can convert the training data into feature vectors for input to the model and test the accuracy using cross-validation methods. For unsupervised learning, the model learns hidden patterns from the unlabeled communication data to find underlying structures and group similar content. The training process involves inputting the communication data into the model, processing it, collecting the output, and comparing it to desired target values. The model parameters can be updated based on the difference between the generated output and target values, with the goal of minimizing a loss function through multiple training iterations. This ongoing training on new communications helps the models adapt and improve their ability to accurately classify and process future messages.

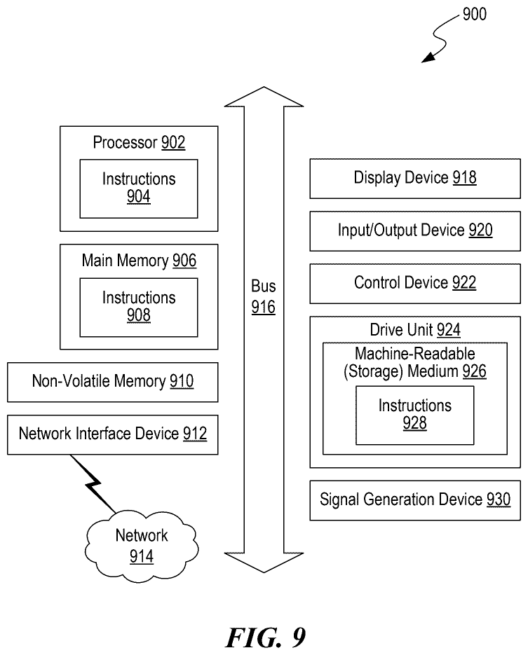

FIG. 8 is a block diagram illustrating an example AI system 800 that can implement aspects of the present technology. The AI system 800 is implemented using components of the example computer system 900 illustrated and described in more detail with reference to FIG. 9. For example, the AI system 800 can be implemented on the processor 902 using instructions 908 programmed in the memory 906 illustrated and described in more detail with reference to FIG. 9. Likewise, implementations of the AI system 900 can include different and/or additional components or be connected in different ways. FIG. 8 illustrates a layered architecture of AI system 800 that can implement the system 400 of FIG. 4, in accordance with some implementations of the present technology.

As shown, the AI system 800 can include a set of layers that conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form an example AI model 830. The optimizer 826, loss function engine 824, and regularization engine 828 work to refine and optimize the AI model 830, and the data layer 802 provides resources and support for application of the AI model 830 by the application layer 808.

The data layer 802 acts as the foundation of the AI system 800 by preparing data for the AI model 830. As shown, the data layer 802 can include two sub-layers: a hardware platform 810 and one or more software libraries 812. The hardware platform 810 can be designed to perform operations for the AI model 830 and include computing resources for storage, memory, logic, and networking, such as the resources described in relation to FIG. 9. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include computing resources, (e.g., servers, memory, etc.) offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include INTEL Math Kernel Library, NVIDIA cuDNN, EIGEN, and OpenBLAS.

The structure layer 804 can include an ML framework 814 and an algorithm 816. The ML framework 814 can be thought of as an interface, library, or tool that allows users to build and deploy the AI model 830. The ML framework 814 can include an open-source library, an API, a gradient-boosting library, an ensemble method, and/or a deep learning toolkit that work with the layers of the AI system to facilitate development of the AI model 830. For example, the ML framework 814 can distribute processes for application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830. Examples of ML frameworks 814 that can be used in the AI system 800 include TENSORFLOW, PYTORCH, SCIKIT-LEARN, KERAS, LightGBM, RANDOM FOREST, and AMAZON WEB SERVICES.

The algorithm 816 can be an organized set of computer-executable operations used to generate output data from a set of input data and can be described using pseudocode. The algorithm 816 can include complex code that allows the computing resources to learn from new input data (e.g., the electronic communications described in more detail with reference to FIGS. 4-7) and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map electronic communications to graph nodes) based on labeled training data. The training data may be labeled by an external user or operator. For instance, a user may collect a set of training data, such as from electronic communication systems, and the like. In an example implementation, training data can include native-format data collected (e.g., electronic communications) from various source computing systems described in relation to FIG. 4. Furthermore, training data can include pre-processed data generated by various engines of the system 400 described in relation to FIG. 4. The user may label the training data based on one or more classes and trains the AI model 830 by inputting the training data to the algorithm 816. The algorithm determines how to label the new data based on the labeled training data. The user can facilitate collection, labeling, and/or input via the ML framework 814. In some instances, the user may convert the training data to a set of feature vectors for input to the algorithm 816. Once trained, the user can test the algorithm 816 on new data to determine if the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data, and are used when input data for the algorithm 816 is discrete. Said differently, when learning through classification techniques, the algorithm 816 receives training data labeled with categories (e.g., classes) and determines how features observed in the training data (e.g., images, text, video clips, audio clips, or web links) relate to the categories (e.g., a professional context, a romantic conversation, or an educational context). Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Said another way, unsupervised learning is used to train the algorithm 816 to find an underlying structure of a set of data, group the data according to similarities, and represent that set of data in a compressed format. The system 400 can use unsupervised learning to identify patterns in digital content history (e.g., to identify communication patterns) and so forth.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 816 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 may be trained to be an Isolation Forest, local outlier factor (LOF) algorithm, or k-nearest neighbor (k-NN) algorithm. Latent variable techniques involve relating observable variables to a set of latent variables. These techniques assume that the observable variables are the result of training on the latent variables and that the observable variables have nothing in common after controlling for the latent variables. Examples of latent variable techniques that may be used by the algorithm 816 include factor analysis, item response theory, latent profile analysis, and latent class analysis.

The model layer 806 implements the AI model 830 using data from the data layer 802 and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model 830 of the AI system 800. The model structure 820 defines the complexity of the pattern/relationship that the AI model 830 expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how a node converts data received to data output. The structure layers may include an input layer of nodes that receive input data and an output layer of nodes that produce output data. The model structure 820 may include one or more hidden layers of nodes between the input and output layers. The model structure 820 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For instance, when the model structure 820 is a neural network, the model parameters 822 can weight and bias the nodes in each layer of the neural networks such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the AI model's performance during training. For instance, the loss function engine 824 can measure the difference between a predicted output of the AI model 830 and the actual output of the AI model 830 and is used to guide optimization of the AI model 830 during training to minimize the loss function. The loss function may be presented via the ML framework 814 such that a user can determine whether to retrain or otherwise alter the algorithm 816 if the loss function is over a threshold. In some instances, the algorithm 816 can be retrained automatically if the loss function is greater than the threshold. Examples of loss functions include a binary-cross entropy function, hinge loss function, regression loss function (e.g., mean square error, or quadratic loss), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model. Examples of optimizers include gradient descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 826 used may be determined based on the type of model structure 820 and the size of data and the computing resources available in the data layer 802.

The regularization engine 828 executes regularization operations. Regularization is a technique that prevents over-and under-fitting of the AI model 830. Overfitting occurs when the algorithm 816 is overly complex and too adapted to the training data, which can result in poor performance of the AI model 830. Under-fitting occurs when the algorithm 816 is unable to recognize even basic patterns from the training data such that it cannot perform well on training data or on validation data. The optimizer 826 can apply one or more regularization techniques to fit the algorithm 816 to the training data properly, which helps constrain the resulting AI model 830 and improves its ability for generalized application. Examples of regularization techniques include lasso (L1) regularization, ridge (L2) regularization, and elastic (L1 and L2 regularization).

The application layer 808 describes how the AI system 800 is used to solve problems or perform tasks. In an example implementation, the system 400 shown by FIG. 4 includes the application layer 808.

### Computer System

FIG. 9 is a block diagram that illustrates an example of a computer system 900 in which at least some operations described herein can be implemented. As shown, the computer system 900 can include: one or more processors 902 (sometimes referred to as data processors), main memory 906, non-volatile memory 910, a network interface device 912, a display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the Figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, and machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above and any that may be listed in accompanying filing papers are incorporated herein by reference in their entireties, except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A non-transitory, computer-readable storage medium comprising instructions recorded thereon, wherein the instructions, when executed by at least one data processor of a computer system, cause the computer system to:
obtain multiple electronic communications from a frontend client;
generate multiple labels for the electronic communications using at least one of a self-hosted large language model or an open-source large language model,
wherein the labels indicate content of the electronic communications;
store the electronic communications and the labels in a semantic search cluster distributed across multiple computer servers,
wherein the electronic communications are classified within the semantic search cluster using the labels;
analyze multiple semantic patterns within the content of the electronic communications;
generate, using the at least one of the self-hosted large language model or the open-source large language model, reusable templates for responding to the electronic communications based on the semantic patterns;
obtain, from the frontend client, an additional electronic communication;
assign a label to the additional electronic communication,
wherein assigning the label includes performing steps to:
compare the additional electronic communication to the electronic communications using semantic similarity, and
determine, based on the comparison, that the additional electronic communication is semantically similar to one of the electronic communications,
wherein the one of the electronic communications is associated with the label; and
provide, to a user device, one of the reusable templates corresponding to the one of the electronic communications for responding to the additional electronic communication.

2. The non-transitory, computer-readable storage medium of claim 1, wherein the semantic search cluster is stored among multiple blocks,
wherein at least one of the blocks is nested within another one of the blocks,
wherein the at least one of the blocks includes a parent attribute defining inheritance of at least one permission from the another one of the blocks,
wherein each electronic communication is stored in a respective one of the blocks, and
wherein the respective one of the blocks includes:
a unique identifier referencing the respective one of the blocks, and
at least one attribute associated with the each electronic communication.

3. The non-transitory, computer-readable storage medium of claim 1, wherein the computer system is caused to:
perform sentiment flow analysis on the electronic communications in the semantic search cluster using the semantic patterns.

4. The non-transitory, computer-readable storage medium of claim 1, wherein the computer system is caused to:
detect that a particular electronic communication is spam based on a semantic pattern of the particular electronic communication.

5. The non-transitory, computer-readable storage medium of claim 1, wherein the computer system is caused to:
provide, to the user device, an application programming interface for querying the semantic search cluster.

6. The non-transitory, computer-readable storage medium of claim 1, wherein storing the electronic communications and the labels in the semantic search cluster reduces application programming interface calls to the at least one of the self-hosted large language model or the open-source large language model.

7. The non-transitory, computer-readable storage medium of claim 1, wherein the computer system is caused to:
train the at least one of the self-hosted large language model or the open-source large language model using the additional electronic communication.

8. A computer system comprising:
at least one hardware processor; and
at least one non-transitory memory storing instructions, which, when executed by the at least one hardware processor, cause the computer system to:
obtain multiple electronic communications from a frontend client;
generate multiple labels for the electronic communications using a large language model;
store the electronic communications and the labels in a semantic search cluster;
analyze multiple semantic patterns within the electronic communications;
generate, using the large language model, reusable templates for responding to the electronic communications based on the semantic patterns;
obtain an additional electronic communication;
assign a label to the additional electronic communication,
wherein assigning the label includes performing steps to:
determine that the additional electronic communication is semantically similar to one of the electronic communications that is associated with the label; and
provide, to a user device, one of the reusable templates corresponding to the one of the electronic communications for responding to the additional electronic communication.

9. The computer system of claim 8, wherein the electronic communications are classified within the semantic search cluster using the labels.

10. The computer system of claim 8, wherein the computer system is caused to:
perform sentiment flow analysis on the electronic communications in the semantic search cluster using the semantic patterns.

11. The computer system of claim 8, wherein the computer system is caused to:
detect that a particular electronic communication is spam based on a semantic pattern of the particular electronic communication.

12. The computer system of claim 8, wherein the computer system is caused to:
provide, to the user device, an application programming interface for querying the semantic search cluster.

13. The computer system of claim 8, wherein storing the electronic communications and the labels in the semantic search cluster reduces application programming interface calls to the large language model.

14. The computer system of claim 8, wherein the computer system is caused to:
train the self-hosted large language model using the additional electronic communication.

15. A method comprising:
obtaining multiple electronic communications from a frontend client;
generating multiple labels for the electronic communications using a large language model;
storing the electronic communications and the labels in a semantic search cluster;
analyzing multiple semantic patterns within the electronic communications;
generating reusable templates for responding to the electronic communications based on the semantic patterns;
obtaining an additional electronic communication;
assigning a label to the additional electronic communication,
wherein assigning the label comprises:
determining that the additional electronic communication is semantically similar to one of the electronic communications that is associated with the label; and
providing, to a user device, one of the reusable templates corresponding to the one of the electronic communications for responding to the additional electronic communication.

16. The method of claim 15, wherein the electronic communications are classified within the semantic search cluster using the labels.

17. The method of claim 15, comprising:
performing sentiment flow analysis on the electronic communications in the semantic search cluster using the semantic patterns.

18. The method of claim 15, comprising:
detecting that a particular electronic communication is spam based on a semantic pattern of the particular electronic communication.

19. The method of claim 15, comprising:
providing, to the user device, an application programming interface for querying the semantic search cluster.

20. The method of claim 15, wherein storing the electronic communications and the labels in the semantic search cluster reduces application programming interface calls to the large language model.
